(19) United States
(12) Patent Application Publication
(10) Pub. No.: US 2026/0258639 A1
(43) Pub. Date: Sep. 3, 2026

(54) MACHINE GUIDANCE PROGRAM AND EXCAVATOR USING SAME

(71) Applicant: HD HYUNDAI INFRACORE CO., LTD., Incheon (KR)

(72) Inventor: Han Sol KIM, Incheon (KR)

(21) Appl. No.: 18/867,475

(22) PCT Filed: Jun. 2, 2023
(86) PCT No.: PCT/KR2023/007628

§ 371 Date: Nov. 20, 2024

(30) Foreign Application Priority Data
Jun. 3, 2022 (KR) 10-2022-0068373

(51) Int. Cl. E02F 9/26; E02F 3/32

(52) U.S. Cl. CPC E02F 9/264; E02F 3/32

(57) ABSTRACT

Embodiments of the present disclosure relate to a machine guidance program and an excavator using same. A machine guidance method for assisting manipulation of an excavator operator may include: an operation of receiving information on the excavator; an operation of determining an operation mode of the excavator based on the information on the excavator; an operation of configuring a construction of a machine guidance screen corresponding to the operation mode; and an operation of displaying the machine guidance screen in the configured construction according to the determined operation mode.

### TECHNICAL FIELD

Various embodiments of the present disclosure relate to a machine guidance program and an excavator using the same.

### BACKGROUND ART

Generally, various kinds of construction equipment such as excavators, dozers, payloaders, dump trucks, and the like are used in the earthworks of a construction work. Among the various kinds of construction equipment, excavators perform important functions in the works of excavation, leveling, and loading.

Specifically, excavators perform various works in addition to the basic works, such as excavation works of digging the ground at civil engineering, building, and construction sites, a loading work of transporting soil onto dump trucks, a demolition work of dismantling buildings and rocks, a clearing work of clearing the ground, and a work of lifting heavy objects or picking up objects using tongs.

The structure of an excavator may be divided into a lower drive body in charge of moving the equipment, an upper rotating body mounted on the top of the lower drive body to rotate 360 degrees, and a work device attached on the front side of the upper rotating body, and the upper rotating body has an operator compartment (cabin) in which an excavator operator sits.

Meanwhile, as the construction equipment such as an excavator operates mainly based on intuitive determination and experience of an operator, quicker and more accurate reactions are essential when a dangerous situation occurs.

Recently, new systems or programs called Machine Guidance (MG), Machine Control (MC), or the like are applied to the construction equipment to solve the problems of absence of skilled operators, safety management, and profitability. For example, a machine guidance system may provide convenience to operators by collecting information related to operation of construction equipment through sensors and displaying the information on a user screen (display).

However, according to the prior art, there is inconvenience in that the operator should change the user screen and continuously handle the user screen to secure the field of vision whenever the operation of the construction equipment is changed.

In addition, there is a problem in that work efficiency may be lowered when the operator manually switches the user screen in each operation of the construction equipment, and safety accidents may occur due to the operator's lack of attention during the work.

### DISCLOSURE

### Technical Problem

The present disclosure provides a display method that automatically switches and presents a user screen according to the operation mode of construction equipment without separate handling of buttons.

The technical problems to be solved in the present disclosure are not limited to the technical problems mentioned above, and unmentioned other technical problems may be clearly understood by those skilled in the art from the following description.

### Technical Solution

According to various embodiments of the present disclosure, a machine guidance method of an excavator may comprise receiving information on the excavator, determining an operation mode of the excavator based on the information on the excavator, setting a configuration of a machine guidance screen corresponding to the operation mode, and displaying the machine guidance screen in the set configuration according to the determined operation mode.

According to various embodiments of the present disclosure, the determining an operation mode of the excavator may include determining whether the excavator is in a work mode or in a drive mode.

According to various embodiments of the present disclosure, the machine guidance method may further comprise determining the operation mode of the excavator as a third mode when a third motion of the excavator is detected in the work mode or the drive mode of the excavator.

According to various embodiments of the present disclosure, when the operation mode of the excavator is determined as the third mode, the setting a configuration of a machine guidance screen may include setting the configuration of the machine guidance screen to maintain a previously displayed configuration of the machine guidance screen.

According to various embodiments of the present disclosure, when a change in an angle value of at least one among a boom, an arm, and a bucket of the excavator is greater than a preset first threshold value, the determining an operation mode of the excavator may include determining the operation mode of the excavator as the work mode.

According to various embodiments of the present disclosure, when a change in a position coordinate value of the excavator is greater than a preset second threshold value, the determining an operation mode of the excavator may include determining the operation mode of the excavator as the drive mode.

According to various embodiments of the present disclosure, when the operation mode of the excavator is determined as the drive mode, the displaying the machine guidance screen corresponding to the determined operation mode may include displaying a first machine guidance screen including a three-dimensional view that displays a plan view displaying a top view of the excavator seen from a top to a bottom on a two-dimensional map and a side view of the excavator seen from a diagonal line at one side on a three-dimensional map.

According to various embodiments of the present disclosure, when the operation mode of the excavator is determined as the work mode, the displaying the machine guidance screen corresponding to the determined operation mode may include displaying a second machine guidance screen including a front view visually showing a degree of alignment between a cross-section of an end portion of a bucket of the excavator and a target surface and a side view visually showing a degree of alignment between a back side of the bucket and a lateral side target surface.

According to various embodiments of the present disclosure, an excavator may comprise a sensor device, a storage device in which a machine guidance program of the excavator is recorded, a display device, and a processor executing the machine guidance program and displaying a machine guidance screen on the display device.

Here, the processor may receive information on the excavator, determine an operation mode of the excavator based on the information on the excavator, set a configuration of the machine guidance screen corresponding to the determined operation mode, and display the machine guidance screen on the display device in the set configuration according to the operation mode.

According to various embodiments of the present disclosure, the processor may determine the operation mode of the excavator as any one among a work mode, a drive mode, and a third mode.

According to various embodiments of the present disclosure, when a change in an angle value of at least one among a boom, an arm, and a bucket of the excavator is greater than a preset first threshold value, the processor may determine the operation mode of the excavator as the work mode.

According to various embodiments of the present disclosure, when a change in a position coordinate value of the excavator is greater than a preset second threshold value, the processor may determine the operation mode of the excavator as the drive mode.

According to various embodiments of the present disclosure, when the operation mode of the excavator is determined as the drive mode, the processor may display a first machine guidance screen including a three-dimensional view that displays a plan view displaying a top view of the excavator seen from a top to a bottom on a two-dimensional map and a side view of the excavator seen from a diagonal line at one side on a three-dimensional map on the display device.

According to various embodiments of the present disclosure, when the operation mode of the excavator is determined as the work mode, the processor may display a second machine guidance screen including a front view visually showing a degree of alignment between a cross-section of an end portion of a bucket of the excavator and a target surface and a side view visually showing a degree of alignment between a back side of the bucket and a lateral side target surface on the display device.

According to various embodiments of the present disclosure, when the operation mode of the excavator is determined as the third mode, the processor may set the configuration of the machine guidance screen to maintain a previously displayed configuration of the machine guidance screen.

According to various embodiments of the present disclosure, when a method of partitioning the machine guidance screen is set to a 2-partition screen, the processor may set the configuration of the machine guidance screen so that a machine guidance screen corresponding to the third mode and a previously displayed machine guidance screen may be displayed on each of partitioned screens.

### Advantageous Effects

According to the embodiments of the present disclosure, work efficiency can be improved by automatically switching and displaying a user screen according to the operation mode of construction equipment without separate handling of buttons by utilizing a machine guidance program.

In addition, according to the embodiments of the present disclosure, as an optimal screen suitable for an operation mode of the construction equipment is provided to the operator, safety accidents that may occur due to distraction of the operator may be prevented in advance.

The effects that can be obtained from the present disclosure are not limited to the effects mentioned above, and unmentioned other effects will be clearly understood by those skilled in the art from the following description.

### DESCRIPTION OF DRAWINGS

FIG. 1 is a view showing an autonomous work system according to various embodiments of the present disclosure.

FIG. 2 is a view for explaining an excavator according to various embodiments of the present disclosure.

FIG. 3 is a view conceptually showing an excavator according to various embodiments of the present disclosure.

FIG. 4 is a flowchart illustrating a method of providing a machine guidance screen according to an operation mode of an excavator according to various embodiments of the present disclosure.

FIG. 5 is a flowchart illustrating a method of determining an operation mode of an excavator according to various embodiments of the present disclosure.

FIGS. 6 and 7 are views showing machine guidance screens according to various embodiments of the present disclosure.

FIG. 8 is a flowchart illustrating a method of providing a machine guidance screen according to an operation mode of an excavator according to various embodiments of the present disclosure.

FIG. 9 is a view showing a machine guidance screen according to various embodiments of the present disclosure.

### MODE FOR INVENTION

The advantages and features of the present disclosure and the devices and methods for achieving them will become apparent by referring to the embodiments described below in detail together with the accompanying drawings. However, the present disclosure is not limited to the embodiments disclosed below, but may be implemented in various different forms, and the embodiments are provided only to make the disclosure of the present disclosure complete and to fully inform those skilled in the art of the scope of the disclosure, and the present disclosure is defined only by the scope of the claims. Like reference numerals refer to like elements throughout the specification.

When a component is referred to as being “connected to” or “coupled to” another component, it includes both the case where it is directly connected or coupled to another component and the case where other components are intervened therebetween. On the other hand, when a component is referred to as being “directly connected to” or “directly coupled to” another component, it indicates that there are no other components intervening therebetween. The term “and/or” includes each of the mentioned items and one or more of all combinations thereof.

The terms used in this specification are for describing the embodiments and are not intended to limit the present disclosure. In this specification, a singular form includes plural forms unless the context clearly dictates otherwise. The terms “comprises” and/or “comprising” used in the specification implies that the mentioned components, steps, operations, and/or elements do not exclude the presence or addition of one or more other components, steps, operations, and/or elements.

Although the terms first, second, and the like are used to describe various components, these components are not limited by these terms. These terms are used only to distinguish one component from another.

Therefore, it is apparent that a first component mentioned below may also be a second component within the technical spirit of the present disclosure. Unless otherwise defined, all terms (including technical and scientific terms) used in this specification may be used as a meaning that can be commonly understood by those skilled in the art. In addition, the terms defined in a commonly used dictionary will not be ideally or excessively interpreted unless explicitly and specifically defined.

The term ‘unit’ or ‘module’ used in the present embodiment means software or a hardware component such as an FPGA or an ASIC, and the ‘unit’ or ‘module’ performs certain functions. However, the ‘unit’ or ‘module’ is not a meaning limited to software or hardware. The ‘unit’ or ‘module’ may be configured to be located in an addressable storage medium or may be configured to operate one or more processors. Accordingly, for example, the ‘unit’ or ‘module’ may include components such as software components, object-oriented software components, class components, task components, processes, functions, attributes, procedures, subroutines, segments of program code, drivers, firmware, microcode, circuits, data, databases, data structures, tables, arrays, and variables. The functions provided in the components and the ‘units’ or ‘modules’ may be combined into a smaller number of components and ‘units’ or ‘modules’, or may be further separated into additional components and ‘units’ or ‘modules’.

The steps of a method or algorithm described in connection with some embodiments of the present disclosure may be directly implemented in hardware, a software module, or a combination of the two executed by a processor. The software module may reside in RAM memory, flash memory, ROM memory, EPROM memory, EEPROM memory, registers, a hard disk, a detachable disk, a CD-ROM, or any other forms of recording medium known in the art. An exemplary recording medium is coupled to the processor, and the processor may read and write information from and to the recording medium. As another method, the recording medium may be integrated with the processor. The processor and the recording medium may reside in an application specific integrated circuit (ASIC). The ASIC may reside in a user terminal.

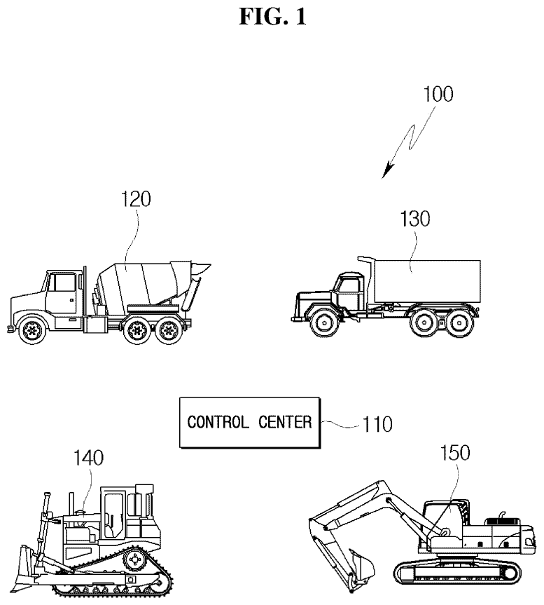

FIG. 1 is a view showing an autonomous work system 100 according to various embodiments of the present disclosure.

Referring to FIG. 1, the autonomous work system 100 according to various embodiments may include a control center 110 and at least one construction equipment (or autonomous work construction equipment) 120 to 150.

According to various embodiments, the construction equipment 120 to 150 refers to machines that conduct works at civil engineering or construction sites, and may include a mixer truck 120, a dump truck 130, a dozer 140, and an excavator 150 as shown in FIG. 1. However, this is only an example, and the construction equipment may include various machines such as a crane, a wheel loader, a scraper, and the like.

According to an embodiment, the construction equipment 120 to 150 may perform work by an operator according to a work order received from the control center 110. According to another embodiment, the construction equipment 120 to 150 may perform work autonomously without an operator. The work order may include information related to a work area in which the construction equipment performs the work, the work to be conducted in the work area, and the like. For example, the construction equipment 120 to 150 may move to the work area and perform the work without or based on handling of the user according to the work order.

The construction equipment 120 to 150 may be provided with various sensors, and may detect the state of the construction equipment and/or the surrounding environment of the construction equipment based on information acquired through the sensors, and take into account results of the detection in performing the work.

In addition, the construction equipment 120 to 150 may be provided with a dashboard that may display information on the construction equipment 120 to 150 or set control on the construction equipment 120 to 150. According to an embodiment, as the dashboard is provided with a touch sensor that may receive touch input of the user, it may acquire information on an image on the dashboard that the user has touched to execute. The construction equipment 120 to 150 may collect and transmit dashboard touch information of the user to the control center 110.

According to various embodiments, the control center 110 may be a system that manages at least one piece of construction equipment 120 to 150 deployed in a work site. According to an embodiment, the control center 110 may order at least one piece of construction equipment 120 to 150 to do a work. For example, the control center 110 may generate a work order that defines a work area and a work to be conducted in the work area, and transmit the work order to at least one piece of construction equipment 120 to 150.

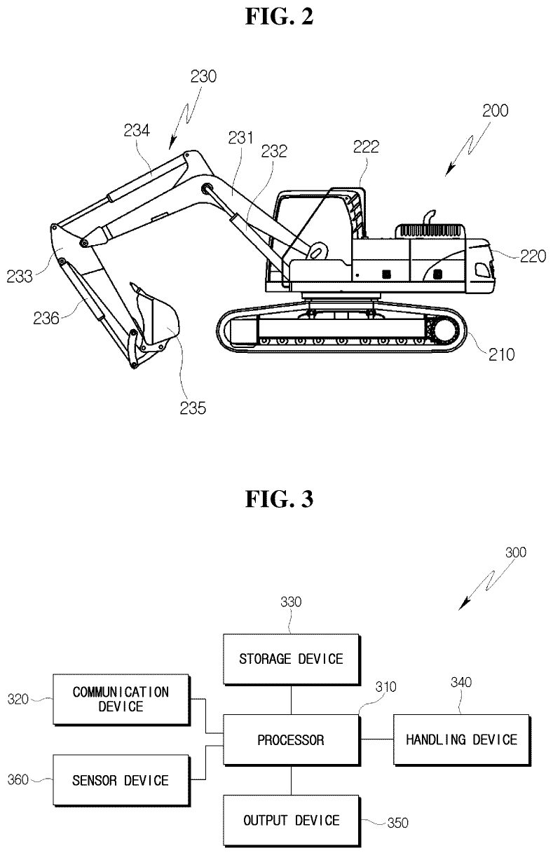

FIG. 2 is a view for explaining an excavator according to various embodiments of the present disclosure. In the following description, the excavator among the construction equipment shown in FIG. 1 is described as an example, but the construction equipment is not limited to the excavator.

Referring to FIG. 2, the excavator 200 may be configured of a lower body 210 in charge of moving, an upper body 220 mounted on the lower body 210 to rotate 360 degrees, and a front working device 230 coupled to the front side of the upper body 220. However, this is only an example, and the embodiment of the present disclosure is not limited thereto. For example, in addition to the components of the excavator 200 described above, one or more other components (e.g., a plate coupled to the rear side of the lower body 210, and the like) may be added.

According to various embodiments, the upper body 220 may be provided with an inner space (not shown) in which an operating room 222 is provided and a power generation device (e.g., an engine) may be mounted. The operating room 222 may be provided at a position close to the work area. The work area is a space in which the excavator 200 works, and is located in front of the excavator 200. For example, the operator on board performs work under a secured field of vision, and the operating room 222 may be located at a position biased to one side on the upper body 220 while being close to the work area as shown in FIG. 2a considering the location where the front working device 230 is mounted.

According to various embodiments, the front working device 230 may be a device mounted on the top surface of the upper body 220 to perform works such as excavating land, transporting objects of a large weight, or the like. According to an embodiment, the front working device 230 may include a boom 231 rotatably coupled to the upper body 220, a boom cylinder 232 for rotating the boom 231, an arm 233 rotatably coupled to the front end of the boom 231, an arm cylinder 234 for rotating the arm 233, a bucket 235 rotatably coupled to the front end of the arm 233, and a bucket cylinder 236 for rotating the bucket 235. When the excavator 200 works, one end of the boom 231, one end of the arm 233, and one end of the bucket 235 may each individually rotate to maximize the area that the bucket 235 may reach. As the front working device 230 described above is known in many documents, detailed description thereof will be omitted.

According to various embodiments, the lower body 210 may be coupled to the bottom surface of the upper body 220. The lower body 210 may include a driving body formed in a wheel type using wheels or a crawler type using an infinite track. The driving body may implement forward, backward, left, and right movement of the excavator 200 using power generated by a power generation device as the driving force. According to an embodiment, the lower body 210 and the upper body 220 may be rotatably coupled by a center joint.

According to various embodiments, the excavator 200 may include a plurality of sensors for collecting information related to operation of the excavator and/or information related to the surrounding environment.

In an embodiment, the plurality of sensors may include a first sensor for detecting operation of the excavator 200. For example, the operation of the excavator 200 may include rotational operation of the upper body 220 (or the lower body 210). The first sensor may be disposed at the center joint to detect the rotational operation of the upper body 220. In addition, the operation of the excavator 200 may include rotational operation of the front working device 230. The first sensor may be disposed at each of the boom 231, the arm 233, and the bucket 235, or at the joints (e.g., hinge joints) of the boom 231, the arm 233, and the bucket 235 to detect rotational operation of at least one among the boom 231, the arm 233, and the bucket 235. The location of the first sensor described above is an embodiment, and the present disclosure is not limited thereto, and the first sensor may be disposed at various locations capable of detecting the state of the excavator 200.

According to an embodiment, the plurality of sensors may include a second sensor for detecting a work area in which the excavator 200 performs work. As described above, the work area is a space in which the excavator 200 performs work and may be located in front of the excavator 200. The second sensor may be disposed at a portion of the upper body 220 close to the work area, for example, at one side close to the front working device 230 on the top surface of the operating room 222, to detect the work area. However, this is only an example, and the location of the second sensor is not limited thereto. For example, the second sensor may be additionally or optionally disposed on the front working device 230, for example, the arm 233 or the bucket 235, to detect the work area.

According to an embodiment, the plurality of sensors may include a third sensor for detecting obstacles around the excavator 200. The third sensor may be disposed at the front, side, and rear of the upper body 220 to detect obstacles around the excavator 200. The location of the third sensor described above is an embodiment, and the present disclosure is not limited thereto, and the third sensor may be disposed at various locations to detect obstacles around the excavator 200.

According to various embodiments, the various sensors described above may include angular sensor, inertial sensor, rotation sensor, electromagnetic wave sensor, a camera sensor, radar, LiDAR, ultrasonic sensor, and the like. For example, the first sensor may be configured of at least one among the angular sensor, the inertial sensor, and the rotation sensor, and the second sensor and the third sensor may be configured of at least one among the electromagnetic wave sensor, the camera sensor, the radar, the LiDAR, and the ultrasonic sensor. For example, camera sensors disposed on the top surface of the operating room 222 and on the arm 233 of the excavator 200 may be used as the second sensor. In addition, the LiDAR disposed on the front side of the excavator 200, ultrasonic sensors disposed on the lateral and rear sides of the excavator 200, or camera sensors disposed on the front, lateral, and rear sides of the excavator 200 may be used as the third sensor. Additionally or optionally, when an image sensor is used as the second sensor and the third sensor, it may be configured as a stereo vision system capable of acquiring an image from which distance information of the target object can be known.

In addition, each of the first sensor, the second sensor, and the third sensor may perform an operation the same as or similar to the operation of the other sensors. For example, the operation of the second sensor that detects a work area where the excavator 200 performs work may be performed using the third sensor for detecting obstacles around the excavator 200.

According to various embodiments, the excavator 200 is capable of performing unmanned automation, in other words, autonomous operation, and may include at least one positioning device or acquire positioning information from an external device.

According to an embodiment, a Global Navigation Satellite System (GNNS) module capable of receiving satellite signals may be used as the positioning device, and a Real Time Kinematic (RTK) GNSS module may be used for precise measurement. For example, at least one positioning device may be disposed on the upper body 220 of the excavator 200.

FIG. 3 is a view conceptually showing an excavator 300 according to various embodiments of the present disclosure. The excavator 300 described through FIG. 3 may be the excavator 200 shown in FIG. 2.

Referring to FIG. 3, the excavator 300 may include a processor 310, a communication device 320, a storage device 330, a handling device 340, an output device 350, and a sensor device 360. However, this is only an example, and the embodiment of the present disclosure is not limited thereto. For example, at least one of the components of the excavator 300 described above may be omitted, or one or more other components may be added as the configuration of the excavator 300.

According to various embodiments, the communication device 320 may transmit and receive data to and from an external device using a wireless communication technique. The external device may include a control center 110, other display devices (e.g., smartphones, laptops, tablets, or the like), and/or other construction equipment. At this point, the communication technique used by the communication device 320 includes Global System for Mobile communication (GSM), Code Division Multi Access (CDMA), Long Term Evolution (LTE), 5G, Wireless LAN (WLAN), Wireless-Fidelity (Wi-Fi), Bluetooth, Radio Frequency Identification (RFID), Infrared Data Association (IrDA), ZigBee, Near Field Communication (NFC), and the like. In addition, the communication device 320 may include at least one positioning device as described above through FIG. 2.

According to various embodiments, the storage device 330 may store various data used by at least one component of the excavator 300 (e.g., the processor 310, the communication device 320, the handling device 340, the output device 350, or the sensor device 360). According to an embodiment, the storage device 330 may store specifications of the excavator 300 (e.g., model name, unique number, basic specifications), map data, and the like. According to an embodiment, the storage device 330 may store design drawings that the excavator 300 is to work on. The design drawings may be stored in the storage device 330 by the user, or the excavator 300 may be connected to the control center 110 through the communication device 320 and acquire and store the design drawings in the storage device 330. Some information of the design drawings may be displayed on a machine guidance screen described below. According to an embodiment, the storage device 330 may include at least one among a non-volatile memory device and a volatile memory device.

According to various embodiments, the handling device 340 may receive commands or data to be used for controlling the operation of the excavator 300. The handling device 340 may include a handling lever for operating at least a part of the front working device 230 (e.g., the boom 231, the arm 233, and the bucket 235), a handle for handling steering of the lower body 210, a shift gear lever for handling the moving speed or forward and backward driving of the excavator 300, and the like. According to an embodiment, the handling device 340 may be provided in the operating room 222 described above through FIG. 2.

According to various embodiments, the output device 350 may generate an output related to the operation of the excavator 300. According to an embodiment, the output device 350 may include a display for outputting visual information, an audio data output device for outputting auditory information, a haptic module for outputting tactile information, and the like. For example, the display may include a liquid crystal display (LCD), a light emitting diode (LED) display, an organic light emitting diode (OLED) display, a micro electromechanical system (MEMS) display, electronic paper, and the like. In addition, the audio data output device may include at least one among a speaker, an earphone, an ear set, and a headset included in the excavator 300 or connected to the excavator 300 through wired/wireless communication.

According to various embodiments, the sensor device 360 may include a first sensor for detecting operation of the excavator 300, a second sensor for detecting a work area in which the excavator 300 performs work, and/or a third sensor for detecting obstacles around the excavator 300. In addition, sensors needed for operation of the excavator 300 may be added.

According to various embodiments, the processor 310 may be configured to control the overall operation of the excavator 300. According to an embodiment, the processor 310 may execute software (e.g., a program) stored in the storage device 330 to control at least one of the components connected to the processor 310 (e.g., the communication device 320, the storage device 330, the handling device 340, the output device 350, or the sensor device 360), and perform various data processing or calculation. For example, as at least part of the data processing or calculation, the processor 310 may store commands or data received from other components in the storage device 330, process the commands or data stored in the storage device 330, and store result data in the storage device 330. The processor 310 may be configured as a main processor and a secondary processor that may operate independently or together with the main processor. According to an embodiment, the processor 310 may perform Controller Area Network (CAN) communication with the components described above (e.g., the communication device 320, the storage device 330, the handling device 340, the output device 350, and the sensor device 360), but the present disclosure is not limited thereto.

According to an embodiment, a machine guidance program may be installed in the excavator 300 to assist the operator, and the processor 310 executing the machine guidance program may display images acquired through a camera sensor or information received through the control center 110 on a display device. For example, the processor 310 may determine the operation mode of the excavator 300 according to the movement of the excavator 300, and control the output device 350 to display a different screen (or view) according to each operation mode.

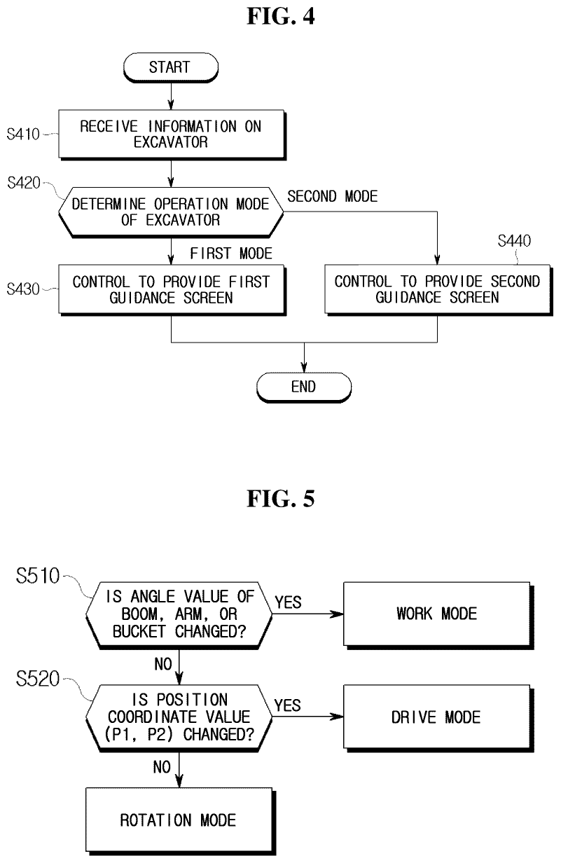

According to an embodiment, the processor 310 determines the operation mode of the excavator 300 as a drive mode when the position coordinate value of the excavator 300 changes, and controls the output device 350 to display a screen showing the position of the excavator 300. According to another embodiment, the processor 310 determines the operation mode of the excavator 300 as a work mode when the angle value of the front working device 230 of the excavator 300 changes, and controls the output device 350 to provide the operator with a machine guidance screen that guides the operator in which direction the front working device 230 should be operated. Meanwhile, a method of providing a machine guidance screen according to the operation mode of the excavator 300 and a method of determining the operation mode of the excavator 300 will be described in more detail with reference to FIGS. 4 and 5 below.

FIG. 4 is a flowchart illustrating a method of providing a machine guidance screen according to an operation mode of an excavator 300 according to various embodiments of the present disclosure. FIG. 5 is a flowchart illustrating a method of determining an operation mode of an excavator 300 according to various embodiments of the present disclosure. Although the operations may be performed sequentially in the following embodiment, they are not necessarily performed sequentially. In addition, the following operations may be performed by the processor 310 of the excavator 300 or may be implemented as commands that can be executed by the processor 310. In addition, although the excavator is described as an example of the construction equipment in the following description, the present disclosure is not limited to the excavator.

Referring to FIG. 4, the processor 310 of the excavator 300 according to various embodiments may receive information on the excavator 300 in operation S410. The information on the excavator 300 may include information on the position or speed of the excavator 300, information on the angle of each member of the excavator 300, and the like, but the present disclosure is not limited thereto, and the processor 310 may receive various information for detecting operation of the excavator 300.

In operation S420, the processor 310 according to various embodiments may determine the operation mode of the excavator 300 based on the information on the excavator 300.

According to an embodiment, the processor 310 may receive an angle value of the front working device 230 of the excavator 300 using an angle sensor, and when the angle value of the front working device 230 changes, the processor 310 may determine the operation mode of the excavator 300 as a work mode (hereinafter, a first mode).

According to another embodiment, when movement of the excavator 300 is detected, the processor 310 may receive coordinate information according to the location of the excavator 300 from the control center 110 or the positioning device, and when the location coordinate value of the excavator 300 changes, the processor 310 may determine the operation mode of the excavator 300 as a drive mode (hereinafter, a second mode).

Meanwhile, the processor 310 may determine the operation mode of the excavator 300 as a rotation mode when the position coordinate value of the excavator 300 does not change and the angle value of the front working device 230 does not change even when movement of the excavator 300 is detected.

In operation S430, when the operation mode of the excavator 300 is the first mode, the processor 310 according to various embodiments may control the output device 350 to display a first machine guidance screen showing the operation of the front working device 230. The first machine guidance screen may be a screen showing the front and lateral sides of the front working device 230, through which the operator may more accurately confirm the alignment state between the front working device 230 and the target surface of the design drawing.

In operation S440, when the operation mode of the excavator 300 is the second mode, the processor 310 according to various embodiments may control the output device 350 to display a second machine guidance screen showing the location of the excavator 300. The second machine guidance screen may be a screen that shows the excavator 300 and the terrain around the excavator 300 based on the current location of the excavator 300.

Referring to FIG. 5, the processor 310 of the excavator 300 according to various embodiments may determine the operation mode of the excavator 300 as the work mode when the angle value of the front working device 230 changes in operation S510. According to an embodiment, the processor 310 may determine the operation mode of the excavator 300 as the work mode when the angle change value of each of the boom, the arm, and the bucket is greater than the vibration value at the time when the excavator 300 is stopped. To this end, the processor 310 may acquire the vibration values of each of the boom, the arm, and the bucket when the excavator 300 is in the stop mode through the sensor device 360, and may determine the operation mode of the excavator 300 considering each of the vibration values when determining the operation mode.

According to an embodiment, the processor 310 may determine whether the angular change value of each of the boom, the arm, and the bucket is greater than the vibration value of each of the boom, the arm, and the bucket and determine the operation mode according to equation 1 shown below. In equation 1 shown below, the arm or the bucket may be applied instead of the boom.

$$\vert ( New boom angle - New body pitch angle ) - ( Old boom angle - Old body pitch angle ) \vert > Set boom vibration value \qquad [ Equation 1 ]$$

In operation S520, the processor 310 according to various embodiments may determine the operation mode of the excavator 300 as the drive mode when the position coordinate value of the excavator 300 changes. According to an embodiment, the processor 310 may determine the change in the position coordinate value considering both the position value acquired through the sensor located at the rear of the excavator 300 and the position value acquired through the sensor located at the center axis of the excavator 300.

In addition, the processor 310 according to an embodiment may determine the operation mode of the excavator 300 as the work mode when the angle change value of the boom, arm, and bucket of the excavator 300 is detected even when the position coordinate value of the excavator 300 is detected. That is, in the example of FIG. 5, operation S510 is executed first to preferentially determine whether the operation mode is the work mode, and when it is not the work mode, operation S520 is executed to determine whether it is the drive mode.

The processor 310 according to various embodiments may determine the operation mode of the excavator 300 as the rotation mode when the position coordinate value of the excavator 300 does not change and the angle value of the front working device 230 does not change. The processor 310 according to an embodiment may control to maintain the displayed screen for continuity of the operation of the excavator 300 when the operation mode of the excavator 300 is the rotation mode. This will be described below in more detail in FIG. 8.

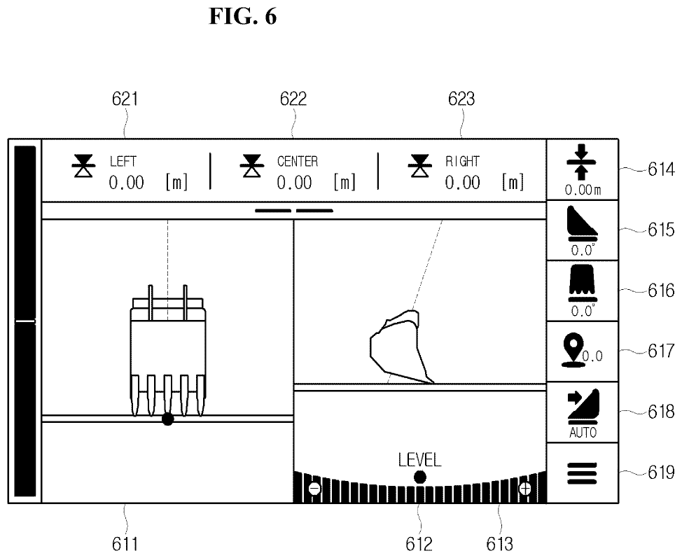

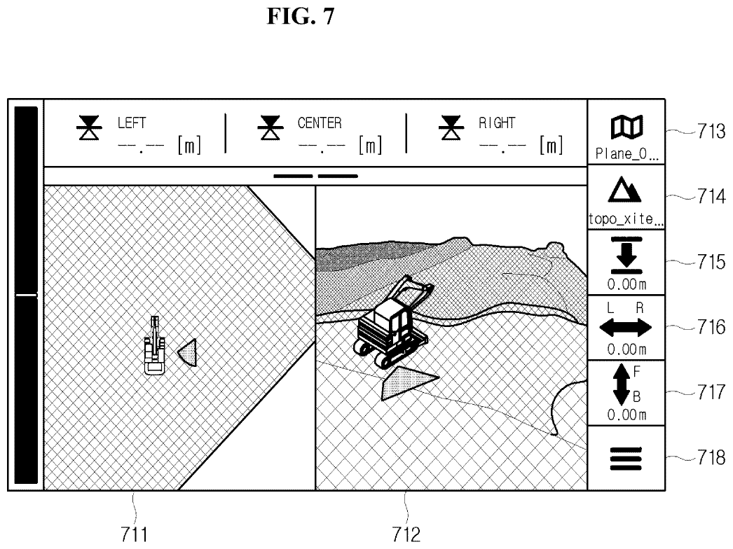

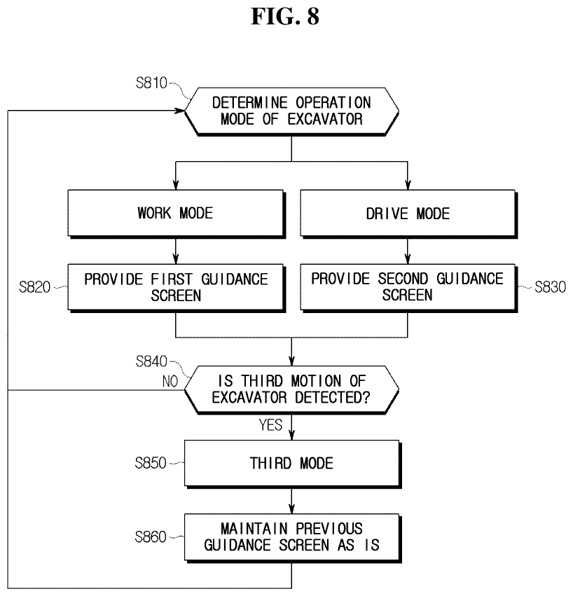

FIGS. 6 and 7 are views showing machine guidance screens according to various embodiments of the present disclosure.

According to an embodiment, FIG. 6 shows an example of a first machine guidance screen displayed through the output device, and FIG. 7 shows an example of a second machine guidance screen displayed through the output device. The configuration examples of the machine guidance screens shown in FIGS. 6 and 7 may be configured in different shapes as an embodiment, and in addition, additional configurations (e.g., a channel view that displays a camera image showing the work area) may be further included or some configurations may be removed.

Referring to the machine guidance screen of FIG. 6, the first machine guidance screen may include a front view 611 that visually shows the degree of alignment between the cross-section of the end portion of the bucket and the target surface of the design drawing seen from the front side, a side view 612 that visually shows the degree of alignment between the back side of the bucket and the lateral side target surface of the design drawing seen from the lateral side, and a guide indicator 613 that guides the operator the direction to which the bucket should be handled. According to an embodiment, the front view 611 may additionally include a bucket front side icon indicating the shape of the front side of the bucket of the excavator 300 and a first line indicating the target surface of the design drawing. In addition, the side view 612 may additionally include a bucket lateral side icon indicating the shape of the lateral side including the back side of the bucket of the excavator 300 and a second line indicating the lateral side target surface of the design drawing.

According to an embodiment, when the operation mode of the excavator 300 is the work mode, the processor 310 of the excavator 300 may control to display the front view 611 and the side view 612 together through the output device 350.

According to an embodiment, in the front view 611 or the side view 612, the bucket-shaped icon may be displayed to be aligned or tilted as shown in FIG. 6 according to the degree of alignment between the bucket and the target surface of the design drawing. In addition, the guide indicator 613 may include a ball shape and a series of bars supporting the ball. The length of the series of bars may increase from the center toward the left and right, but this is only one embodiment, and the series of bars may be displayed in another shape, or as another form, one bar may be displayed from the left end to the right end. In addition, the position of the guide indicator 613 may also be located at the top of the side view 612 to be different from the guide indicator 613 shown in FIG. 6.

The ball shape of the guide indicator 613 may move left and right according to the degree of alignment on the series of bars. In addition, − indicator may be placed near the left end of the area indicated by the series of bars to show the operator that the operator should operate in the − tilting direction based on the angle between the cross-section of the end portion of the bucket and the target surface of the design drawing, and + indicator may be placed near the right end to show the operator that the operator should operate in the + tilting direction.

Additionally, the second machine guidance screen may include a target depth value 614, an angle 615 between the back side of the bucket and the target surface, and an angle 616 between the end portion of the bucket and the target surface.

According to an embodiment, the operator may set the target depth value 621 of the left side area of the bucket, the target depth value 622 of the center area of the bucket, and the target depth value 623 of the right side area of the bucket by directly inputting the values when the operator presses or touches the target depth value 614, or may set the values by receiving a design drawing from the control center 110.

In addition, the first machine guidance screen may further display a reference point setting button 617, an autonomous work execution mode button 618 for autonomously performing work without an operator, and a machine guidance-related setting entry button 619.

According to an embodiment, when the end portion of the bucket of the excavator may be placed at an actual reference position, and the reference point setting button 617 is pressed or touched, the position may be set as a reference. In addition, the target depth value 614, target slope values seen from the front and lateral sides, and the like may be set by inputting through a separate menu based on the reference point, or may be set by receiving a design drawing from the control center 110.

As shown in FIG. 6, the first machine guidance screen, in which information is provided by the machine guidance program, may display horizontal alignment information of the target line and the bucket.

The first machine guidance screen may visually provide the operator with whether the target drawing line and the back side of the bucket are horizontally aligned using the side view 612 and the guide indicator 613, and may also intuitively show handling of the bucket in the rotation direction that the operator should perform to horizontally align the target drawing line and the back side of the bucket.

In addition, although not shown in FIG. 6, the first machine guidance screen may visually provide the operator with whether the target drawing line and the end portion of the bucket of the bucket are horizontally aligned using the front view 611 and the guide indicator 613, and may also intuitively show the direction of adjusting the angle of the bucket that the operator should perform to horizontally align the target drawing line and the end portion of the bucket.

According to an embodiment, the operator may set a method of partitioning the user screen by pressing or touching the machine guidance-related setting entry button 619. For example, the operator may set the output method of the user screen to display an image of a two-partition screen or a three-partition screen according to the operation mode of the construction equipment.

Referring to the machine guidance screen of FIG. 7, the second machine guidance screen may show the position of the construction equipment relative to the working drawing and the topographic drawing. Specifically, the second machine guidance screen may include a plan view 711 that two-dimensionally shows the top view of the construction equipment seen from the top to the bottom and a three-dimensional view 712 that three-dimensionally shows the side view of the construction equipment seen from a diagonal line at one side. According to an embodiment, the processor 310 of the excavator 300 may control to display the plan view 711 and the three-dimensional view 712 together through the output device 350 when the operation mode of the excavator 300 is the drive mode.

Additionally, the second machine guidance screen may show map and terrain display buttons 713 and 714 for receiving and displaying map and terrain information from the control center 110, and may further show a depth offset setting button 715, a left/right offset setting button 716 for setting an offset in the left/right or west/east direction relative to the body, a front/back offset setting button 717 for setting an offset in the front/back or north/south direction relative to the body, and a machine guidance-related setting entry button 718.

As described above, the machine guidance program provided in the excavator according to the present invention may improve work efficiency by automatically switching and displaying the user screen according to the operation mode of the excavator without separately handling a button.

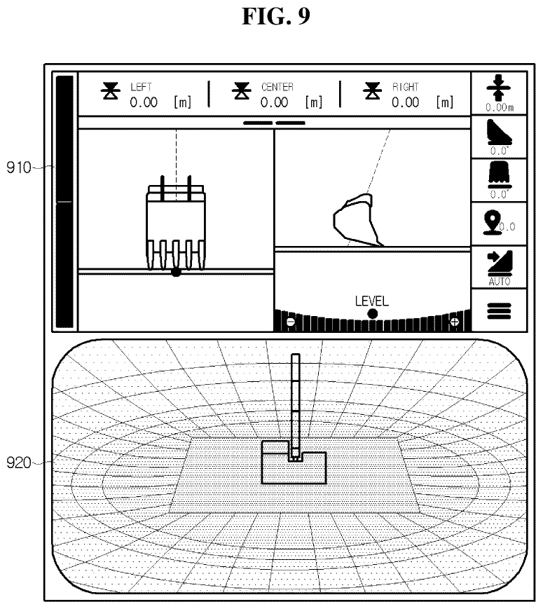

FIG. 8 is a flowchart illustrating a method of providing a machine guidance screen according to an operation mode of an excavator according to various embodiments of the present disclosure. FIG. 9 is a view showing a machine guidance screen according to various embodiments of the present disclosure. Although the operations of FIG. 8 described below may be performed sequentially, they are not necessarily performed sequentially. For example, the order of the operations may be changed, and at least two operations may be performed in parallel. In addition, as repeatedly explained above, the following operations may be performed by the processor 310 of the excavator 300 or may be implemented as commands that can be executed by the processor 310.

Referring to FIG. 8, in operation S810, the processor 310 of the excavator 300 according to various embodiments may determine the operation mode of the excavator 300 based on information on the excavator 300. For example, the processor 310 may determine the operation mode of the excavator 300 as the work mode when the position coordinate value of the excavator 300 does not change and a change in the angle value of the front working device 230 is detected. In addition, the processor 310 may determine the operation mode of the excavator 300 as the drive mode when the angle value of the front working device 230 does not change and a change in the position coordinate value of the excavator 300 is detected.

When it is determined that the operation mode of the excavator 300 is the work mode, in operation S820, the processor 310 according to various embodiments may control the output device 350 to provide a machine guidance screen that shows the operation of the front working device 230.

When it is determined that the operation mode of the excavator 300 is the drive mode, in operation S830, the processor 310 according to various embodiments may control the output device 350 to provide a machine guidance screen that shows the position of the excavator 300.

In operation S840, the processor 310 according to various embodiments may determine whether a third motion of the excavator 300 is detected based on information on the position or speed of the excavator 300, information on the angle of each member of the excavator 300, information on the operation of the excavator 300, and the like in the work mode or drive mode of the excavator 300.

In operation S850, when movement of the excavator 300 and movement of the front working device 230 are detected simultaneously or rotation of the upper body 220 relative to the lower body 210 of the excavator 300 is detected, the processor 310 according to various embodiments may determine the operation mode of the excavator 300 as a third mode.

When it is determined that the operation mode of the excavator 300 is the third mode, in operation S860, the processor 310 according to various embodiments may control the output device 350 to maintain the previously displayed machine guidance screen. For example, when a third motion of the excavator 300 is detected in the work mode or drive mode of the excavator 300, the processor 310 may control the output device 350 to maintain the previously displayed machine guidance screen as is for continuity of the operation of the excavator 300.

That is, when a third motion of the excavator 300 is detected in the work mode of the excavator 300, the processor 310 of the excavator 300 may control to display a front view and a side view corresponding to the work mode through the output device 350, and when the third motion of the excavator 300 is detected in the drive mode of the excavator 300, the processor 310 may control to display a plan view and a three-dimensional view corresponding to the drive mode through the output device 350.

The processor 310 according to various embodiments may control the output device 350 to display an image of a two-partition screen or a three-partition screen by the setting of the operator of the excavator 300 or according to the operation mode of the excavator 300. In this case, different screens may be displayed in each of the partitioned areas in correspondence to the operation mode of the excavator 300.

For example, as shown in FIG. 9, when the operation mode of the excavator 300 is switched from the work mode to the third mode, the processor 310 may control the output device 350 so that a machine guidance screen 910 showing the operation of the front working device 230 and an around view 920 showing a surrounding image within a predetermined distance from the excavator 300 may be displayed in each partitioned area on each partitioned screen.

Meanwhile, although it is shown in FIG. 9 that the machine guidance screen 910 showing the operation of the front working device 230 and the around view 920 are displayed together in each partitioned area corresponding to the operation mode of the excavator 300, it is not limited thereto, and the processor 310 may set the configuration of the machine guidance screen to display the machine guidance screen 910 showing the operation of the front working device 230 and a view showing information on the amount of work loaded on construction equipment such as a dump truck or the like in each partitioned area, display a machine guidance screen showing the position of the excavator 300 and the around view 920 in each partitioned area, or display a machine guidance screen showing the position of the excavator 300 and a view showing information on the amount of work loaded on construction equipment such as a dump truck or the like in each partitioned area.

The machine guidance program and the machine guidance screen or a user interface (UI) of the excavator 300 according to the embodiments of the present disclosure may be implemented as commands that can be executed by a processor (e.g., the processor 310) and stored in a computer-readable storage medium, and the processor may display the configured UI or machine guidance screen on the display by reading a corresponding command from the storage medium and executing the command.

The storage medium may include a database including a distributed type, such as a relational database, a non-relational database, an in-memory database, or any other appropriate database capable of storing data and allowing access to such data through a storage controller, regardless of whether directly and/or indirectly or in a raw state, a formatted state, an organized state, or any other accessible state. In addition, the storage medium may include any type of storage device, such as primary storage, secondary storage, tertiary storage, offline storage, volatile storage, non-volatile storage, semiconductor storage, magnetic storage, optical storage, flash storage, hard disk drive storage, floppy disk drive, magnetic tape, or any other appropriate data storage medium.

Although the present disclosure has been described with reference to the embodiments illustrated in the drawings, these are only an example, and those skilled in the art will understand that various modifications and equivalent other embodiments are possible therefrom. Accordingly, the true technical protection scope of the present disclosure should be determined by the technical spirit of the appended claims.

1. A machine guidance method of an excavator, comprising:
receiving information on the excavator;
determining an operation mode of the excavator based on the information on the excavator;
setting a configuration of a machine guidance screen corresponding to the operation mode; and
displaying the machine guidance screen in the set configuration according to the operation mode.

2. The machine guidance method according to claim 1, wherein the determining an operation mode of the excavator comprises determining whether the excavator is in a work mode or in a drive mode.

3. The machine guidance method according to claim 2, further comprising:
determining the operation mode of the excavator as a third mode when a third motion of the excavator is detected in the work mode or the drive mode of the excavator.

4. The machine guidance method according to claim 3, wherein, when the operation mode of the excavator is determined as the third mode, setting a configuration of a machine guidance screen comprises setting the configuration of the machine guidance screen to maintain a previously displayed configuration of the machine guidance screen.

5. The machine guidance method according to claim 2, wherein, when a change in an angle value of at least one among a boom, an arm, and a bucket of the excavator is greater than a preset first threshold value, the determining an operation mode of the excavator comprises determining the operation mode of the excavator as the work mode.

6. The machine guidance method according to claim 2, wherein, when a change in a position coordinate value of the excavator is greater than a preset second threshold value, the determining an operation mode of the excavator comprises determining the operation mode of the excavator as the drive mode.

7. The machine guidance method according to claim 2, wherein, when the operation mode of the excavator is determined as the drive mode, the displaying the machine guidance screen comprises displaying a first machine guidance screen including a three-dimensional view that displays a plan view displaying a top view of the excavator seen from a top to a bottom on a two-dimensional map and a side view of the excavator seen from a diagonal line at one side on a three-dimensional map.

8. The machine guidance method according to claim 2, wherein, when the operation mode of the excavator is determined as the work mode, the displaying the machine guidance screen comprises displaying a second machine guidance screen including a front view visually showing a degree of alignment between a cross-section of an end portion of a bucket of the excavator and a target surface and a side view visually showing a degree of alignment between a back side of the bucket and a lateral side target surface.

9. An excavator comprising:
a sensor device;
a storage device in which a machine guidance program of the excavator is recorded;
a display device; and
a processor executing the machine guidance program, wherein the processor
receives information on the excavator,
determines an operation mode of the excavator based on the information on the excavator,
sets a configuration of a machine guidance screen corresponding to the determined operation mode, and
displays the machine guidance screen on the display device in the set configuration according to the operation mode.

10. The excavator according to claim 9, wherein the processor
determines the operation mode of the excavator as any one among a work mode, a drive mode, and a third mode.

11. The excavator according to claim 10, wherein, when a change in an angle value of at least one among a boom, an arm, and a bucket of the excavator is greater than a preset first threshold value, the processor determines the operation mode of the excavator as the work mode.

12. The excavator according to claim 10, wherein, when a change in a position coordinate value of the excavator is greater than a preset second threshold value, the processor determines the operation mode of the excavator as the drive mode.

13. The excavator according to claim 10, wherein, when the operation mode of the excavator is determined as the drive mode, the processor displays a first machine guidance screen including a three-dimensional view that displays a plan view displaying a top view of the excavator seen from a top to a bottom on a two-dimensional map and a side view of the excavator seen from a diagonal line at one side on a three-dimensional map on the display device.

14. The excavator according to claim 10, wherein, when the operation mode of the excavator is determined as the work mode, the processor displays a second machine guidance screen including a front view visually showing a degree of alignment between a cross-section of an end portion of a bucket of the excavator and a target surface and a side view visually showing a degree of alignment between a back side of the bucket and a lateral side target surface on the display device.

15. The excavator according to claim 10, wherein when the operation mode of the excavator is determined as the third mode, the processor sets the configuration of the machine guidance screen to maintain a previously displayed configuration of the machine guidance screen.

16. The excavator according to claim 10, wherein, when a method of partitioning the machine guidance screen is set to a 2-partition screen, the processor sets the configuration of the machine guidance screen to display a machine guidance screen corresponding to the third mode and a previously displayed machine guidance screen on each of partitioned screens.
